(19) United States
(12) Patent Application Publication
(10) Pub. No.: US 2003/0103541 A1
(43) Pub. Date: Jun. 5, 2003

(54) Fabry-Perot laser

(76) Inventor: Yu Zheng, Cupertino, CA (US)

Correspondence Address: Bo-In Lin, 13445 Mandoli Drive, Los Altos Hills, CA, 94022, US

(21) Appl. No.: 10/095,949

(22) Filed: Mar. 11, 2002

Related U.S. Application Data
(63) Continuation-in-part of application No. 10/010,988, filed on Dec. 5, 2001.

(51) Int. Cl. H01S 3/08

(52) U.S. Cl. 372/92

(57) ABSTRACT

An improved low-cost Fabry-Perot (FP) laser with narrow spectral width and low sensitivity to reflections and temperature variation is disclosed in this invention. The improved FP laser includes a mirror, a laser gain medium (chip), an anti-reflection coating, and a wavelength mirror. The laser chip has the mirror on its non-light emitting facet and the anti-reflection coating on its light emitting facet. The wavelength mirror is coated on a glass substrate. Both the laser chip and the wavelength mirror are fixed onto a submount. The wavelength mirror has a low-cost reflective wavelength filter coating on it. The reflective wavelength filter has a narrow reflective passband width, i.e., less than 2 nm at FWHM, and a peak reflectivity of around 30% with an isolation of over 25 dB outside the reflective passband. Also the reflective wavelength filter has low wavelength thermal dependence of 0.01 nm/C or less.

This is a Continuous-In-Part (CIP) Application of a previously filed co-pending Application with Ser. No. 10/010,988 filed on Dec. 5, 2001, by the Applicant of this invention.

### FIELD OF THE INVENTION

This invention relates generally to a method and configuration for making laser implemented in the optical transmitters for use in optical fiber signal communication systems. More particularly, this invention relates to a method and configuration for providing an improved Fabry-Perot laser at a lower cost while achieving narrow spectral width, low reflection sensitivity and reduced temperature variations.

### BACKGROUND OF THE INVENTION

Even that a Fabry-Perot (FP) laser is commonly employed in the system for carrying out the optical fiber communications, and under many circumstances, a FP laser provides useful functions and appropriate services, the FP laser is however encountered several technical difficulties. Specifically, a conventional FP laser produces laser signals with multiple resonant peaks at several wavelengths and extended over broad a spectral width, a FP laser is not suitable for applications such as wavelength division multiplexing (WDM) communications. On the other hand, a Distributed Feed-Back (DFB) laser is an improved FP laser, in which a distributed Bragg grating is put into the laser cavity of an index-guided FP laser. Due to the grating, only one mode that conforms to the wavelength of the grating can lase. Since it produces only one wavelength, a DFB laser is commonly employed for WDM communications and other applications. However, since an expensive isolator and expensive temperature control are required for a DFB laser package, a DFB laser is not practical for more economical applications that require low cost optical components. Examples of such economical applications are the optical communications systems for metropolitan access. Under many circumstances, a DFB laser is implemented in a metro access system without temperature control for cost reduction. However, an expensive isolator is still required even with coarse wavelength division multiplex applications for metro access. Therefore, the technical difficulties of reflection sensitivities and temperature dependence as now faced by those of ordinary skill in the art still impact the cost for fiber optical implementations when the DFB laser is employed.

A Fabry-Perot (FP) laser is a semiconductor laser based on a FP resonator. FIG. 1 shows the conceptual structure of a typical FP laser 10. The FP laser 10 includes a mirror 20, a laser gain medium (chip) 30, and a partial mirror 40. The pair of the mirrors 20 and 40 forms a FP cavity (resonator). The distance between the mirrors 20 and 40 is relatively short relative to the wavelength of a laser emission inducing light 50. The light 50 undergoes constructive interference within the FP cavity and then gets out from the partial mirror 40. FIG. 2 shows the output spectrum of the FP laser 10. As shown by FIG. 2, a FP laser usually produces an output light with a spectral characteristic that has several light intensity peaks at several resonant wavelengths ranging over a spectral width between 5 to 8 nm. Since its manufacturing cost is relatively low, a FP laser is commonly employed in optical fiber communications. In many situations, it can provide good services. However, since it produces many wavelengths over a spectral width, a FP laser is not suitable for applications such as wavelength division multiplexing (WDM) communications.

The difficulties encountered in a simple FP laser shown above can be solved by dispersing the unwanted wavelength before these unwanted signals reach a threshold for generating the laser emission. A DFB laser is an improved FP laser implemented with this principle. In a DFB laser, a Bragg grating is placed into the laser cavity of an index-guided FP laser. FIG. 3 shows the conceptual structure of a typical DFB laser 10′. The DFB laser includes a mirror 20′, a laser gain medium 30′, a Bragg grating 40′, and an AR coating (or a cleaved facet) 50′. Due to the grating 40′, only a one resonant mode that conforms to the wavelength of the grating 40′ is resonated with constructive interference within the cavity to generate a laser output. Thus, the spectral width of the DFB laser 10′ is greatly improved as compared to a FP laser. FIG. 4 shows the output spectrum of the DFB laser 10′. As shown by FIG. 4, a DFB laser usually produces only one wavelength. Since it produces only one wavelength, a DFB laser is commonly employed for WDM communications and other applications. However, a DFB laser has two disadvantages. First, it is very sensitive to reflections. To minimize the effects of the reflections, an expensive isolator is usually required to be packaged with it. Second, it is sensitive to temperature variations and thus expensive temperature control is usually required as part of the DFB package for applications in a dense WDM communication system. Therefore, even that DFB is able to generate laser output with superior wavelength characteristics, the cost becomes a major practical issue that prevents broad applications of DFB in fiber optical communication.

Therefore, a need exists in the art of design of a FP laser to overcome the difficulties discussed above. Specifically, an improved FB laser configuration with reduced production cost while generates a laser output with narrow spectral distributions and having a low sensitivity to reflections and temperature variations is required.

### SUMMARY OF THE PRESENT INVENTION

It is therefore an object of the present invention to provide a new and improved FP laser configuration that can be manufactured at a lower production cost while generating an output laser with narrow spectral width and operated with low reflection sensitivity and low temperature variations. The aforementioned difficulties and limitations in the prior arts can therefore be resolved by the new and improved FP laser according to the disclosures provided in this invention.

Specifically, it is an object of the present invention to provide an improved FP laser configuration implemented with the wavelength mirror, which can be manufactured at lower cost. Instead of coating the wavelength mirror on the light-emitting facet of a laser chip in the pending patent application, the wavelength mirror is coated on a separate glass substrate and then is diced into small pieces in the present invention. Then a small piece of the glass substrate based wavelength mirror is mounted in the front of the light-emitting facet of a laser chip. Since the uniformity and then the manufacturing yield of the wavelength mirror coating on a big glass substrate are much higher than those on the emitting facet of a laser chip, the manufacturing cost of the improved FP laser is greatly reduced according to the present invention.

Briefly, in a preferred embodiment, the present invention discloses an improved low-cost FP laser with narrow spectral width and low sensitivity to reflections and temperature variations. The improved FP laser includes a mirror, a laser gain medium (chip), an anti-reflection coating, and a wavelength mirror. The wavelength mirror is separately manufactured for mounting and assembling onto the FP laser. The laser chip has the mirror coated on its non-light emitting facet and the anti-reflection coating coated on its light-emitting facet. The wavelength mirror is coated on a glass substrate and then mounted in the front of the light-emitting facet of the laser chip. The wavelength mirror has a low-cost reflective wavelength filter coating on it. The reflective wavelength filter has a narrow passband width, i.e., less than 2 nm at FWHM, and its peak reflectivity is around 30% with isolation of about 25 dB outside its passband. Also, the reflective wavelength filter has low wavelength thermal dependence. The pair of the mirror and the wavelength mirror forms a special FP cavity (resonator).

In another preferred embodiment, the improved FP laser includes a wavelength mirror, an anti-reflection coating, a laser gain medium (chip), and a partial mirror. The laser chip has the anti-reflection coating coated on its non-light emitting facet and the partial mirror coated on its light-emitting facet. The partial mirror, which is different from the wavelength mirror, provides a uniform partial light reflection over a broad wavelength range, i.e., uniform reflection of around 30% over a wavelength passband of 60 nm. The wavelength mirror is coated on a glass substrate and then mounted in the front of the non-light emitting facet of the laser chip. In this preferred embodiment, the wavelength mirror has a narrow passband width, i.e., less than 2 nm at FWHM, and its peak reflectivity is around 95% with isolation of about 25 dB outside its passband. Also, the wavelength mirror has low wavelength thermal dependence. The pair of the wavelength mirror and the partial mirror forms a special FP cavity (resonator).

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

FIG. 1 is the conceptual structure of a typical FP laser;

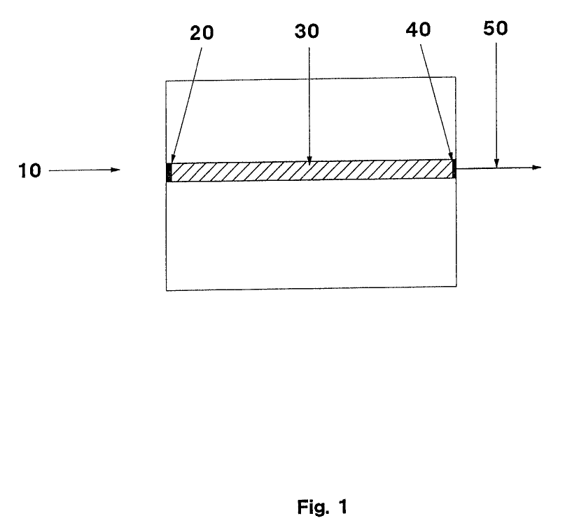

FIG. 2 is the output spectrum of a typical FP laser;

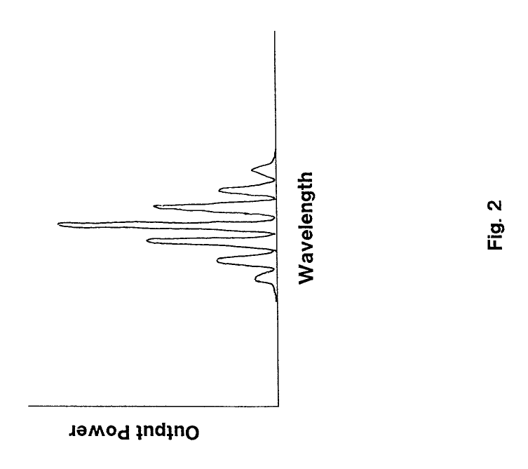

FIG. 3 is the conceptual structure of a typical DFB laser;

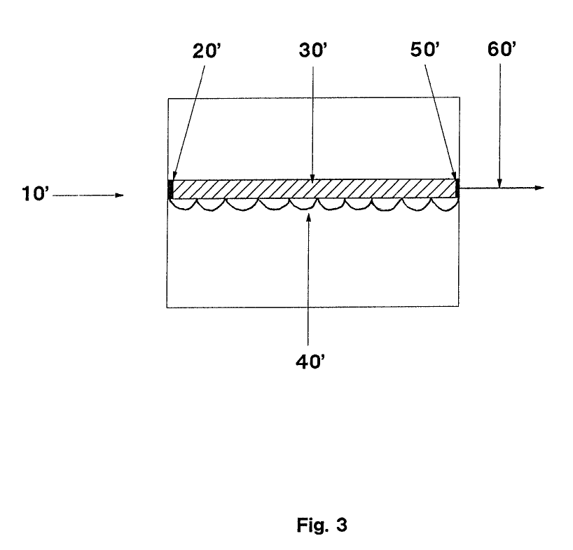

FIG. 4 is the output spectrum of a typical DFB laser;

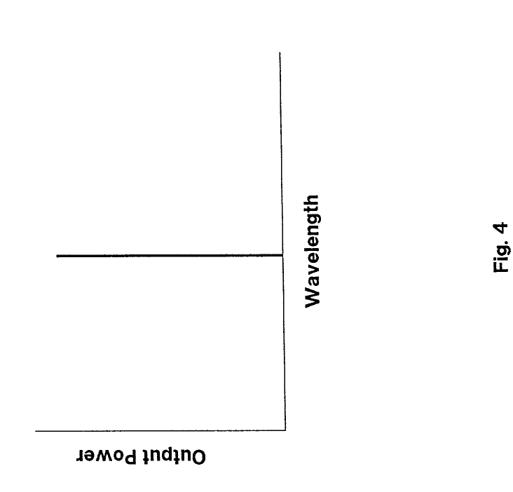

FIG. 5 is the conceptual structure of the FP laser according to the present invention;

FIG. 6 is the reflection spectrum of the wavelength mirror according to the present invention;

FIG. 7 is the output spectrum of the FP laser according to the present invention;

FIG. 8 is a structural diagram of the improved FP laser in a preferred embodiment according to the present invention;

FIG. 9 is another structural diagram of the improved FP laser as an alternate preferred embodiment according to the present invention; and

FIG. 10 is a perspective view of a substrate coated with pass-band reflective coating for manufacturing the wavelength mirror implemented in the present invention.

### DETAILED DESCRIPTION OF THE PREFERRED EMBODIMENT

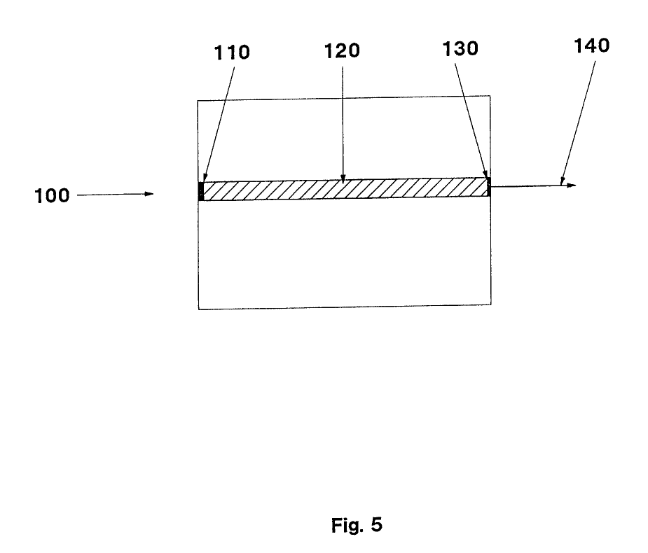

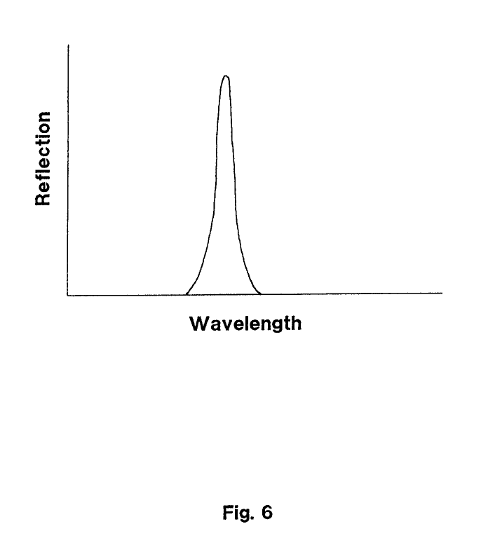

Referring to FIG. 5 for a preferred embodiment of a FP laser 100 of this invention. The new FP laser 100 includes a mirror 110, a laser gain medium (chip) 120, and a wavelength mirror 130. The pair of the mirrors 110 and 130 forms a special FP cavity (resonator). The wavelength mirror 130 is a wavelength-filtering reflective coating. FIG. 6 shows the reflection spectrum of the wavelength-filtering reflective coating 130. In the present invention, the wavelength-filtering reflective coating 130 is designed to have a narrow reflective passband width of less than 2 nm at FWHM and a peak reflectivity of around 30% having approximately 25 dB isolation outside the reflective passband. Also, the wavelength-filtering reflective coating 130 is selected to have low wavelength thermal dependence of about 0.01 nm/C or less.

Since the technology of WDM coating has achieved significant progress in the past few years, a wavelength-selective reflective coating, e.g., coating 130, with the passband characteristic, as that shown in FIG. 6, is readily available at a reasonable price range in the market place. A mirror formed with wavelength-selective reflective coating 130 can be provided within a reasonably low price range and there would be no cost impacts due to the new configuration of employing the wavelength-selective reflective coating 130.

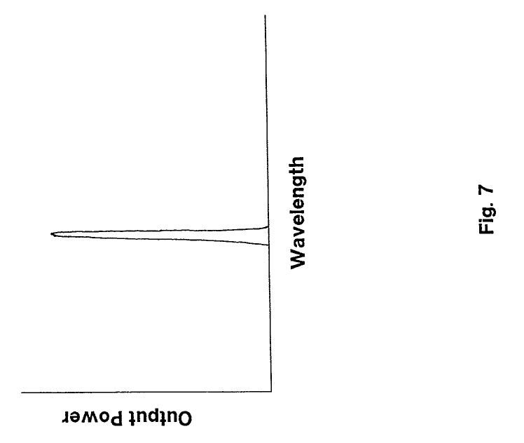

As a preferred embodiment of the present invention, the coating is coated as the wavelength mirror 130 to form a one-cavity wavelength-selective reflective filter. The portion of the signals carried in the light 140 with a wavelength outside the passband of the wavelength-selective reflective 130 are transmitted through the wavelength mirror 130 and prevented from reflecting back into the FP cavity. There would be no constructive interference for the portion of optical signals outside of the passband of the wavelength-selective reflective 130. The optical signals within the pass band of the wavelength-selective coating 130 are reflected back into the FP cavity to undergo constructive interference to produce an output laser 140 projecting out from the wavelength mirror 130. Therefore, the spectral width of the light 140 as that shown in FIG. 7 is defined by the passband width of the reflective wavelength filter 130. Furthermore, due to relatively high reflectivity and low wavelength thermal dependence of the wavelength-selective reflective coating 130, the FP laser 100 of this invention has low sensitivity to reflections and temperature variations. An isolator for preventing external optical incidence into the cavity and a temperature control mechanism to maintain the temperature within a small temperature range is no longer required for most of the applications. The FP laser can be provided with a reduced size and volume since the isolator and temperature controller are no longer necessary as part of the package. Furthermore, with the cost savings achieved by removing the requirements of isolator and temperature controller, the FP laser can be produced and implemented at a significant lower price. Large-scale implementation of FP lasers in metro-access systems at reasonably low price with improved performance in producing laser transmission of sharp and narrow output spectrum and high temperature stability over significant temperature ranges can be practically achieved with the new and improved FP laser of the present invention.

While the above preferred embodiments produce optical output signals of narrow and predefined spectral width, low reflection sensitivity and reduced temperature variation of the FP laser, there are still practical manufacturing difficulties that limit the production yields of the new and improved Fabry-Perot laser. Specifically, the wavelength mirror 130 is coated onto the light-emitting facet of the laser chip 120. Since the laser chip 120 is very thin with a typical thickness of 100 μm, it is quite difficult to coat the wavelength mirror 130 onto the laser chip 120 with a required uniformity. Due to this coating difficulty, the manufacturing yield of the wavelength mirror 130 is decreased as the wavelength mirror 130 coated onto the laser chip 120 cannot meet the uniformity requirement. Therefore, the production cost of the wavelength mirror 130 and thus the FP laser is increased. Further improvements are described below to increase the production yields and to lower the manufacturing cost of the FP laser as that disclosed in FIGS. 5 to 7.

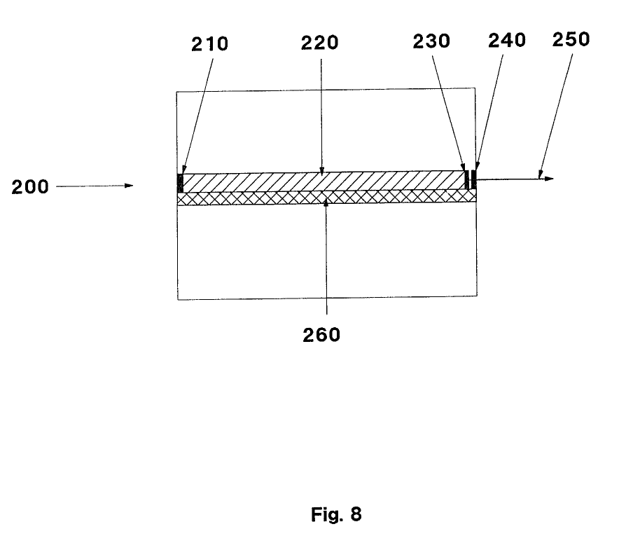

Referring to FIG. 8 for a preferred embodiment of a FP laser 200 of the present invention. The improved FP laser 200 includes a mirror 210, a laser gain medium (chip) 220, an anti-reflection coating 230, a wavelength mirror 240, supported on a submount 260. The mirror 210 is coated to the laser chip 220 on a non-light emitting facet shown as the left end, and an anti-reflection coating 230 coated on a light emitting facet shown as the right end of the laser chip 220. The pair of the mirrors 210 and 240 forms a special FP cavity (resonator) for the light signal 250. The wavelength mirror 240 is identical to the wavelength reflective filter 130 of FIG. 5. In this preferred embodiment, the wavelength mirror 240 is designed to have a narrow reflective passband width of less than 2 nm at FWHM and a peak reflectivity of around 30% having approximately 25 dB isolation outside the reflective passband. Also, the wavelength mirror 240 is selected to have low wavelength thermal dependence of about 0.01 nm/C or less. To form a FP cavity between the pair of the mirrors 210 and 240, the light emitting facet of the laser chip 220 is coated with the anti-reflection coating 230 to prevent light from reflection back into the laser chip by its light emitting facet. The anti-reflection coating is one of the most standard coatings in the laser production and can be routinely done at very low cost. The whole assembly is mounted on the submount 260.

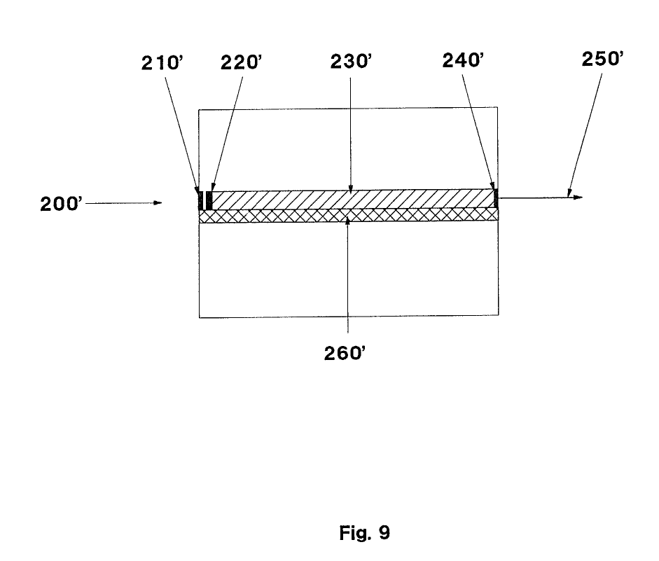

FIG. 9 shows another preferred embodiment of this invention. The FP laser 200′ includes a wavelength mirror 210′ disposed immediately next to a laser gain medium (chip) 230′ coated with an anti-reflection coating 220 right next to the wavelength mirror 210′. A partial mirror 240′ is coated on the facet of the opposite end of the laser chip 230′. As shown in FIG. 9, the left-hand end of the laser chip coated with the anti-reflection (AR) coating 220′ is a non-light emitting facet and the partial mirror 240′ is coated on a light-emitting facet on the right-hand end of the laser chip 230′. The partial mirror, 240′ is different from the wavelength mirror 210′, provides a uniform partial light reflection over a broad wavelength range, i.e., uniform reflection of around 30% over a wavelength passband of 60 nm or more. The wavelength mirror 210′ is manufactured by coating a wavelength-selective reflection filter on a glass substrate and then diced into small lens for mounting on the front end of the non-light emitting facet of the laser chip. In this preferred embodiment, the wavelength mirror 210′ has a narrow passband width, i.e., less than 2 nm at FWHM, and its peak reflectivity is around 95% with isolation of about 25 dB outside its passband. Also, the wavelength mirror 210′ has low wavelength thermal dependence. The pair of the wavelength mirror 210′ and the partial mirror 240′ forms a special FP cavity (resonator) and the whole assembly is then mounted on the submount 260′.

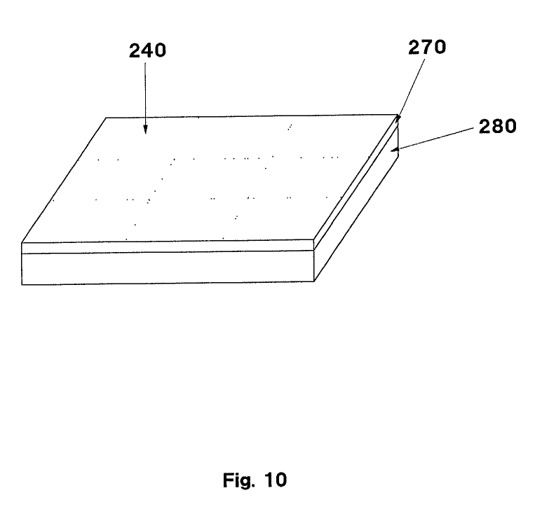

As shown in FIG. 10, instead of forming the wavelength mirror 240 onto the laser chip 220, a wavelength-selective reflective coating filter 270 is coated onto a glass substrate 280. The substrate 280 coated with the wavelength-selective reflective coating layer 270 is then diced into a plurality of small pieces. The characteristics of wavelength selective reflective filtering when formed on the glass substrate 280 is significantly improved over the filter 130 of FIG. 5 coated directly onto the laser chip 120. The manufacture yield is also substantially higher than the process of direct coating processes as described for FIG. 5. After the wavelength selective reflective filter 240 is diced, the filter 240 is mounted onto the sub-mount 260 as that shown in FIG. 8. Thus, the manufacturing cost of the wavelength mirror 240 and then the FP laser 200 of this present invention is greatly reduced as compared to the embodiment as shown in FIG. 5.

In the present invention, since the wavelength mirror is not directly coated on the laser chip, both the laser chip and the wavelength mirror are fixed onto the submount to achieve the thermal stability of the FP laser cavity. The submount can be made of metals or semiconductors and the laser chip and the wavelength mirror can be fixed onto the submount by employing the soldering or alternate methods.

According to the above descriptions, this invention discloses a Fabry-Perot laser 200. The FP laser includes a resonant cavity and that includes a laser gain medium (chip) 220 filling the cavity wherein the cavity having a first end and second end opposite the first end. The FP laser further includes a reflective mirror 210 with a high reflectance disposed on the first end. And, it includes an anti-reflection coating 230 disposed on the second end to prevent the light 250 from reflection back into the laser gain medium by the second end. And, it includes a wavelength mirror 240 disposed on a glass substrate and then located in the front of the second end. The pair of the mirror 210 and the wavelength mirror 240 forms a laser resonant cavity. And, both the laser chip 220 and the wavelength mirror are fixed onto the submount 260 to achieve the thermal stability of the laser resonant cavity. The wavelength mirror 240 is implemented for selectively reflecting a portion of optical signals with a selective range of wavelengths back to the laser resonant cavity and the first mirror 210 for generating a laser through a constructive interference process in the resonant cavity. In a preferred embodiment, the wavelength mirror includes a passband-filter reflective coating 240 for selectively reflecting the portion of optical signals with the selective range of wavelengths matched with a passband of the passband-filter reflective coating. In a preferred embodiment, the laser gain medium filling the cavity constituting an active region for generating a light. In a preferred embodiment, the passband-filter reflective coating has a passband with a width of less than 2 nm at FWHM, a peak reflectivity around 30% and an isolation of about 25 dB outside the passband. In a preferred embodiment, the passband-filter reflective coating has a wavelength thermal dependence of about 0.01 nm/C or less. In a preferred embodiment, the resonant cavity is an elongated cavity with the laser gain medium disposed between the reflective mirror disposed on the first end and the wavelength mirror disposed on a glass substrate.

In a preferred embodiment, this invention further discloses a method for configuring a Fabry-Perot laser. The method includes steps of A) filling a resonant cavity with a laser gain medium. And, B) disposing a reflective mirror with a high reflectance on a first end of the cavity and disposing an anti-reflection coating on a second end opposite the first end. And, C) disposing a wavelength mirror on a glass substrate located in the front of the second end for selectively reflecting a portion of optical signals with a selective range of wavelengths back to the laser gain medium and the first mirror for generating a laser through a constructive interference process in the resonant cavity. And, D) fixing both the laser gain medium and the wavelength mirror on to a submount to achieve the thermal stability of the resonant cavity.

In summary this invention discloses a resonant cavity for generating an output laser. The resonant cavity includes a wavelength mirror for selectively reflecting optical signals within a selective range of wavelength back to the resonant cavity for resonantly generating the output laser wherein the wavelength mirror constituting a separate mirror for assembling onto the resonant cavity. In a preferred embodiment, the wavelength mirror includes a band-reflective filter for selectively reflecting the portion of optical signals with the selective range of wavelengths matched with a reflection band of the band-reflective filter.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. An improved Fabry-Perot laser comprising:
a resonant cavity includes a laser gain medium within said cavity wherein said cavity having a first end and second end opposite said first end; and
a reflective mirror with a high reflectance disposed on said first end and a wavelength mirror disposed on said second end for selectively reflecting a portion of optical signals with a selective range of wavelengths back to said laser gain medium and said first mirror for generating a laser output beam wherein said wavelength mirror being a separate mirror.

2. The Fabry-Perot laser of claim 1 wherein:
said wavelength mirror disposed on said second end includes a band reflective-filter for selectively reflecting said portion of optical signals with said selective range of wavelengths matched with a passband of said band reflective-filter.

3. The Fabry-Perot laser of claim 1 wherein:
said laser gain medium in said cavity constituting an active region for generating a light.

4. The Fabry-Perot laser of claim 1 wherein:
said band-reflective filter has a reflection band with a width of less than 2 nm at FWHM, a peak reflectivity around 30% and an isolation of about 25 dB outside said reflection band.

5. The Fabry-Perot laser of claim 1 wherein:
said band-reflective filter has a wavelength thermal dependence of about 0.01 nm/C or less.

6. The Fabry-Perot laser of claim 1 wherein:
said resonant cavity is an elongated cavity with said laser gain medium disposed between said reflective mirror disposed on said first end and said wavelength-selective reflective mirror disposed on said second end with a distance of N*(λ/4) therein-between wherein λ representing a peak wavelength in said selective range of wavelengths and N is an positive integer.

7. The Fabry-Perot laser of claim 1 further comprising:
an anti-reflective (AR) means disposed between said laser gain medium and said wavelength mirror.

8. The Fabry-Perot laser of claim 1 further comprising:
a mounting means for mounting and supporting said laser gain medium and said wavelength mirror.

9. The Fabry-Perot laser of claim 1 further comprising:
a laser disposed on said second end and said wavelength mirror is having a reflective spectrum width larger than a mode separation of said laser.

10. A resonant cavity for generating an output laser comprising:
a wavelength mirror for selectively reflecting optical signals within a selective range of wavelength back to said resonant cavity for resonantly generating said output laser wherein said wavelength mirror constituting a separate mirror for assembling onto said resonant cavity.

11. The resonant cavity of claim 10 wherein:
said wavelength mirror includes a band-reflective filter for selectively reflecting said portion of optical signals with said selective range of wavelengths matched with a reflection band of said band-reflective filter.

12. The resonant cavity of claim 10 further comprising:
a laser gain medium in said cavity to function as an active region for generating a light.

13. The resonant cavity of claim 10 wherein:
said band-reflective filter has a reflection band with a width of less than 2 nm at FWHM, a peak reflectivity around 30% and an isolation of about 25 dB outside said reflection band.

14. The resonant cavity of claim 10 wherein:
said band-reflective filter has a wavelength thermal dependence of about 0.01 nm/C or less.

15. The resonant cavity of claim 10 wherein:
said resonant cavity is an elongated cavity with a laser gain medium disposed between a reflective mirror disposed on a first end and said wavelength mirror disposed on a second end with a distance of N*(λ/4) therein-between wherein λ representing a peak wavelength in said selective range of wavelengths and N is an positive integer.

16. The resonant cavity of claim 10 further comprising:
an anti-reflective (AR) means attached to said laser gain medium.

17. The resonant cavity of claim 10 further comprising:
a mounting means for mounting and supporting said resonant cavity including said separate wavelength mirror.

18. A method for configuring a Fabry-Perot laser comprising:
providing a laser gain medium in a resonant cavity; and
disposing a reflective mirror with a high reflectance on a first end of said cavity;
manufacturing a wavelength mirror; and
disposing said wavelength mirror on a second end opposite said first end for selectively reflecting a portion of optical signals with a selective range of wavelengths back to said laser gain medium and said first mirror for generating a laser output beam.

19. The method of claim 18 wherein:
said step of disposing said wavelength mirror on said second end comprising a step of mounting said laser gain medium and said wavelength mirror on a mounting and supporting means whereby said wavelength mirror functioning as a reflective passband filter having a passband for selectively reflecting said portion of optical signals with said selective range of wavelengths back to said resonant cavity.

20. The method of claim 18 wherein:
said step of providing said laser gain medium in said cavity is a step of forming active region for generating a light in said cavity.

21. The method of claim 19 wherein:
said step of manufacturing said band-reflective filter comprising a step
a) of coating a substrate with a passband-filter reflective coating with a passband having a width of less than 2 nm at FWHM, a peak reflectivity around 30% and an isolation of about 25 dB outside said passband and a step
b) of dicing said substrate coated with said reflective coating into a plurality of said wavelength mirrors.

22. The method of claim 21 wherein:
said step of coating said substrate with said band-reflective filter reflective coating comprising a step of coating said substrate with a passband-filter reflective coating has a wavelength thermal dependence of about 0.01 nm/C or less.

23. The method of claim 18 further comprising a step of:
configuring said resonant cavity as an elongated cavity having a length of N*(λ/4) wherein λ representing a peak wavelength in said selective range of wavelengths and N is an positive integer.

24. A method of configuring a resonant cavity for generating an output laser comprising:
assembling a separate wavelength mirror onto said resonant cavity for selectively reflecting optical signals within a selective range of wavelength back to said resonant cavity for resonantly generating said output laser.

25. The method of claim 24 wherein:
said step of assembling said wavelength mirror includes a step of mounting said resonant cavity with a band-reflective filter on a mounting means wherein said band-reflective filter having a reflective-passband matching said selective range of wavelengths for selectively reflecting said portion of optical signals with said selective range of wavelengths back to said resonant cavity.

26. The method of claim 24 further comprising a step of:
providing said cavity with a laser gain medium to function as an active region for generating a light.

27. The method of claim 24 wherein:
said step of assembling said wavelength mirror includes a step of manufacturing said wavelength mirror as a band-reflective filter with a reflective passband having a width of less than 2 nm at FWHM, a peak reflectivity around 30% and an isolation of about 25 dB outside said passband.

28. The method of claim 24 wherein:
said step of assembling said wavelength mirror includes a step of manufacturing said wavelength-selective mirror as a band-reflective filter with a wavelength thermal dependence of about 0.01 nm/C or less.

29. The method of claim 24 further comprising a step of:
configuring said resonant cavity as an elongated cavity having a length of N*(λ/4) wherein λ representing a peak wavelength in said selective range of wavelengths and N is an positive integer.
